(19) United States
(12) Patent Application Publication
(10) Pub. No.: US 2021/0256396 A1
(43) Pub. Date: Aug. 19, 2021

(54) SYSTEM AND METHOD OF PROVIDING AND UPDATING RULES FOR CLASSIFYING ACTIONS AND TRANSACTIONS IN A COMPUTER SYSTEM

(71) Applicant: Secude AG, Lucerne (CH)

(72) Inventors: Philipp Meier, Lucerne (CH); David William Reber, Lucerne (CH); Luca Mazzola, Rotkreuz (CH); Andreas Waldis, Rotkreuz (CH); Patrick Siegfried, Rotkreuz (CH); Florian Stalder, Rotkreuz (CH)

(21) Appl. No.: 17/174,837

(22) Filed: Feb. 12, 2021

Related U.S. Application Data
(60) Provisional application No. 62/976,839, filed on Feb. 14, 2020.

(51) Int. Cl. G06N 5/02; G06N 20/00; G06N 5/00; G06K 9/62; G06F 16/28; G06F 16/26

(52) U.S. Cl. CPC G06N 5/025; G06N 20/00; G06F 16/26; G06K 9/6298; G06F 16/287; G06N 5/003

(57) ABSTRACT

The present invention relates to a method and system for providing and updating a rule set used or classifying actions and transactions in computer systems.

The present application claims benefit of and priority to U.S. Provisional Patent Application Ser. No. 62/976,839 filed Feb. 14, 2020 and entitled SYSTEM AND METHOD OF PROVIDING AND UPDATING RULES FOR CLASSIFYING ACTIONS AND TRANSACTIONS IN A COMPUTER SYSTEM, the entire content of which is incorporated by reference herein.

### BACKGROUND

### Field of the Disclosure

The present disclosure relates to a system and method of providing, maintaining and updating rules for classification of actions and transactions in a computer system. In particular, the present disclosure relates to a system and method of providing, maintaining and updating rules for classification of actions and transactions using unsupervised machine learning.

### Related Art

Rule-based decision making is commonly used in computer systems, including enterprise systems, to provide decision making for various situations. These systems may be used in very different contexts and to accomplish heterogeneous tasks, such as classification of medical images, validation of medical reimbursements or identification of fraud in credit card transactions, to name a few.

Another important context is security classification of user interactions with a Management Information System (MIS). The current trend is towards the digitalization of virtually all company activity such that virtually all relevant information, whether used for daily operations or for strategic long-term decisions, has a high probability of being stored in or by a computer system, which is also known as Enterprise Resource Planning (ERP). In such contexts, a multitude of transactions and events must be contemplated by a rule system for classification and protection such that the maintenance of the rule sets is growing evermore complex. Similarly, business applications that hold other types of information such as intellectual property, for example, computer aided design drawings and manufacturing documents which need to be classified and/or protected using the rules.

SAP SE is a market leader in enterprise resource planning (ERP) and provides a proprietary ERP core that is extensible and customizable by clients, through a range of different modules. There are companion products that work with such a core to properly log, classify and protect data exports thereof. The same applies for other market leader(s) and their offerings such as Siemens Teamcenter, PTC Windchill and SAP ECTR, to name a few, to manage, log, classify and protect such data and similar business applications that hold high value data. Such companion products typically make decisions based on rules and classify user requests for sensitivity and financial relevance based on information complementary to the user's official role, the tables or other storage media involved, the type of report requested, the type of terminal/system used, etc.

One shortcoming of such products is that they do not allow for the generation and updating of rules dynamically to ensure that there are suitable rules for all of the varied types of data that such enterprise systems now transfer. In contrast, conventional systems utilize static rule sets that are typically only updatable by user or administrator intervention, which is complex, costly, difficult and subject to error. Conventional systems do not provide for dynamically adding or updating rule sets.

Accordingly, it would be desirable to provide a method and system of establishing and providing rules for classification of requests and transactions in a computer system that avoids these and other problems.

### SUMMARY

It is an object of the present disclosure to provide a system and method that setups, maintains and improves rule sets used in regulating activity classification in a computer system and more specifically in companion applications of business applications and adjunct processes while minimizing human interaction. In embodiments, the system and method utilize data science and machine learning. In embodiments, the system and method are provided in the context of well-defined, stable and structured data input to generate rules suitable for application to complex data classification patterns dynamically.

A method of providing and updating a rule set for classifying actions and transactions in a computer system in accordance with an embodiment of the present disclosure includes: accessing, by a machine learning engine operably connected to the computer system, data associated with data transactions made by the computer system; determining, by the machine learning engine, one or more dimensions associated with the data; identifying, by the machine learning engine, one or more core points associated with the data; identifying, by the machine learning engine, one or more border points associated with the data; connecting, by the machine learning engine, the one or more core points to the one or more border points; identifying, by the machine learning engine, one or more clusters based on the one or more core points and the one or more border points to which they are connected; identifying, by the machine learning engine, one or more outlier points that are not connected to one or more border points; and generating, by the machine learning engine, a first proposed rule based on at least one of the one or more clusters and/or the one or more outlier points.

In embodiments, the method may include sending the first proposed rule to a rule engine associated with the computer system.

In embodiments, the method may include, prior to the sending step, a step of presenting, by the machine learning engine, the first proposed rule generated to a user via a visualization element operably connected to the computer system.

In embodiments, the method may include receiving, by the machine learning engine, verification of the first proposed rule generated in the generating step from the user via the visualization element prior to the sending step.

In embodiments, the generating step may include generating at least a second proposed rule, wherein the second proposed rule is not sent to the rule engine.

In embodiments, the method may include a step of storing the first proposed rule generated by the generating step and the second proposed rule with the data associated with data transactions, wherein the first proposed rule generated by the generating step and the second proposed rule are included in the data associated with data transactions when the accessing step is repeated.

In embodiments, the method may include pre-processing the data associated with data transactions before the accessing step.

In embodiments, the data associated with the data transactions includes export data log information associated with prior exports of data.

In embodiments, the data associated with the data transactions includes metadata associated with a file to be exported.

In embodiments, the data associated with the data transactions includes rules previously generated for the rule set.

In embodiments, the dimensions associated with the data are determined based on a pre-set list associated with the machine learning engine.

In embodiments, the method may include storing, by the machine learning engine, the one or more core points, the one or more border points and the one or more outliers is a memory element operably connected to the computer system.

In embodiments, the method may include presenting, by the machine learning engine, one or more of the one or more core points, the one or more border points and the one or more outliers to a user via a visualization element operably connected to the computer system.

In embodiments, the method may include generating, by the machine learning engine at least one logic tree based on the first proposed rule generated in the generating step and a rule set associated with a rule engine operatively connected to the computer system.

In embodiments, the method may include presenting the at least one logic tree to a user via a visualization element operably connected to the computer system.

A system of providing and updating a rule set for classifying actions and transactions in a computer system in accordance with an embodiment of the present disclosure includes: at least one processor; at least one memory element operably connected to the at least one processor and including processor executable instructions, that when executed by the at least one processor performs the steps of: accessing data associated with data transactions made by the computer system; determining one or more dimensions associated with the data; identifying one or more core points associated with the data; identifying one or more border points associated with the data; connecting the one or more core points to the one or more border points; identifying one or more clusters based on the one or more core points and the one or more border points to which they are connected; identifying one or more outlier points that are not connected to one or more border points; and generating a first proposed rule based on at least one of the one or more clusters and the one or more outlier points.

In embodiments, the memory element may include processor executable instructions, that when executed by the at least one processor perform a step of sending the first proposed rule to a rule engine associated with the computer system.

In embodiments, the memory element may include processor executable instructions, that when executed by the at least one processor perform a step of, prior to the sending step, presenting the first proposed rule generated in the generating step to a user via a visualization element.

In embodiments, the memory element may include processor executable instructions, that when executed by the at least one processor performs a step of receiving verification of the first proposed rule generated in the generating step from the user via the visualization element prior to the sending step.

In embodiments, the memory element may include processor executable instructions that when executed by the at least one processor perform a step of generating a second proposed rule wherein the second proposed rule is not sent to the rule engine.

In embodiments, the memory element may include processor executable instructions, that when executed by the at least one processor performs the step of storing the first proposed rule generated by the generating step and the second proposed rule with the data associated with data transactions, wherein the first proposed rule generated by the generating step and the second proposed rule are included in the data associated with data transactions when the accessing step is repeated.

In embodiments, the memory element may include processor executable instructions, that when executed by the at least one processor perform a step of pre-processing the data associated with data transactions before the accessing step.

In embodiments, the data associated with the data transactions includes export data log information associated with prior exports of data.

In embodiments, the data associated with the data transactions includes metadata associated with a file to be exported.

In embodiments, the data associated with the data transactions includes rules previously generated for the rule set.

In embodiments, the dimensions associated with the data are determined based on a pre-set list associated with the machine learning engine.

In embodiments, the memory element may include processor executable instructions, that when executed by the at least one processor perform a step of storing, by the machine learning engine, the one or more core points, the one or more border points and the one or more outliers is a memory element operably connected to the computer system.

In embodiments, the memory element may include processor executable instructions, that when executed by the at least one processor perform a step of presenting, by the machine learning engine, one or more of the one or more core points, the one or more border points, the one or more clusters and the one or more outliers to a user via a visualization element operably connected to the computer system.

In embodiments, the memory element may include processor executable instructions, that when executed by the at least one processor perform a step of generating, by the machine learning engine at least one logic tree based on the first proposed rule generated in the generating step and a rule set associated with a rule engine operatively connected to the computer system.

In embodiments, the memory element may include processor executable instructions, that when executed by the at least one processor perform a step of presenting the at least one logic tree to a user via a visualization element operably connected to the computer system.

### BRIEF DESCRIPTION OF THE DRAWINGS

FIG. 1 illustrates a block diagram of a computer system that may use the method and system for setting, maintaining and updating a rule set and classification in accordance with an embodiment of the present disclosure;

FIG. 2 illustrates a block diagram illustrating a rule module and a machine learning module operatively connected to one or more databases and file repositories in the computer system of FIG. 1 in accordance with an embodiment of the present disclosure;

FIG. 3 illustrates a block diagram indicating communications between a client application and the computer system of FIG. 1 as well as the databases and file repositories of FIG. 2 in accordance with an embodiment of the present disclosure;

FIG. 4 illustrates an example of an export log used in the computer system of FIG. 1 in accordance with an embodiment of the present disclosure;

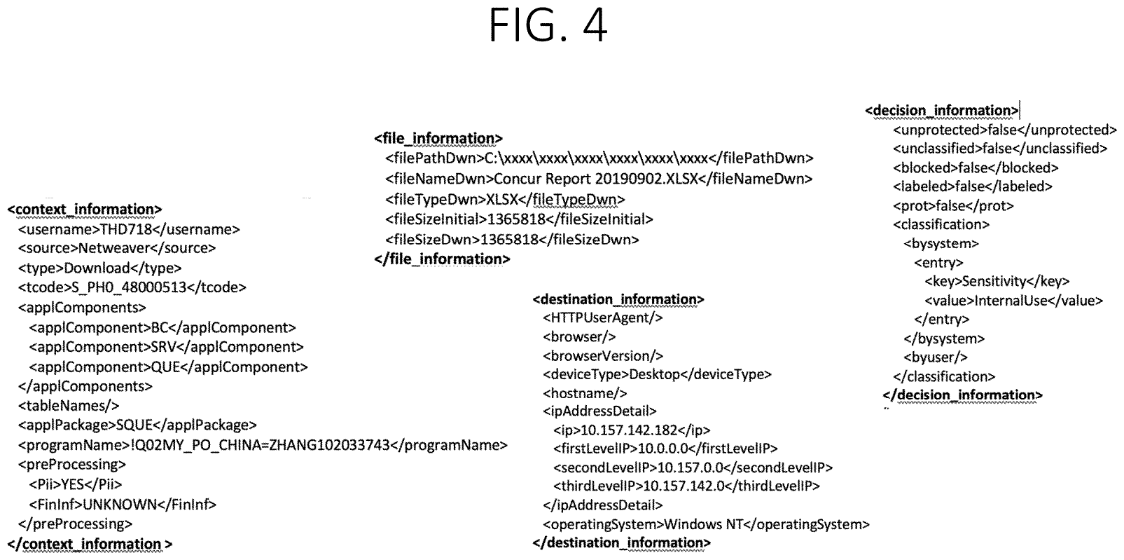

FIG. 5 illustrates an exemplary time-based visualization of the data processed by the machine learning engine of FIG. 2 in accordance with an embodiment of the present disclosure;

FIG. 6 illustrates exemplary visualization of the correlation capabilities of the data processed by the machine learning engine of FIG. 2 in accordance with an embodiment of the present disclosure;

FIG. 7 illustrates an exemplary data browsing visualization of data processed by the machine learning engine of FIG. 2 in accordance with an embodiment of the present disclosure;

FIG. 8 illustrates an exemplary representation of the clusters identified in the data processed by the machine learning engine of FIG. 2 in accordance with an embodiment of the present disclosure;

FIG. 9 illustrates an exemplary representation of the clusters identified in the data processed by the machine learning engine of FIG. 2 and highlighting a particular cluster in accordance with an embodiment of the present disclosure;

FIG. 10 illustrates an exemplary output of the machine learning engine in accordance with an embodiment of the present disclosure;

FIG. 11 illustrates an exemplary list of data attributes, indicating their importance to the cluster, provided in the exemplary output of FIG. 10 in accordance with an embodiment of the present disclosure;

FIG. 12 illustrates an exemplary visual representation of the key aspects of the data identified via the machine learning algorithm implemented by the machine learning engine in accordance with an embodiment of the present disclosure.

FIG. 13 illustrates an exemplary outlier point and its data attributes, identified by the machine learning algorithm implemented by the machine learning engine in accordance with an embodiment of the present disclosure;

FIG. 14 illustrates an exemplary ranking of the data attributes of an outlier point of FIG. 13 in accordance with an embodiment of the present disclosure;

FIG. 15 illustrates an exemplary decision tree that may result based on implementation of rules generated by the machine learning engine in accordance with an embodiment of the present disclosure;

FIG. 16 illustrates an exemplary interface presenting a decision tree map where each point may be represented with a rectangle whose surface correlates with the number of data points in accordance with an embodiment of the present disclosure;

FIG. 17 illustrates exemplary rules including the relevant conditions and resulting classifications associated therewith in accordance with an embodiment of the present disclosure;

FIG. 18 illustrates additional exemplary rules including actions associated with each in accordance with an embodiment of the present disclosure;

FIG. 19 illustrates an exemplary flow chart illustrating the steps performed by the machine learning engine to generate a rule based on data associated with data transactions in the computer system in accordance with an embodiment of the present disclosure;

FIG. 19A illustrates an exemplary flow chart illustrating the steps performed by the machine learning engine to generate a rule based on data associated with data transactions in the computer system in accordance with another embodiment of the present disclosure; and

FIG. 19B illustrates another exemplary flow chart illustrating the steps performed by the machine learning engine to generate a rule based on data associated with data transactions in the computer system in accordance with another embodiment of the present disclosure; and

FIG. 20 illustrates an exemplary flow chart illustrating a method of pre-processing data that may take place prior to providing the data to the machine learning engine in accordance with an embodiment of the present disclosure;

FIG. 21 illustrates an exemplary flow chart illustrating exemplary steps for exporting data at or close to start-up of the method and system of the present disclosure in accordance with an embodiment of the present disclosure;

FIG. 22 illustrates an exemplary flow chart illustrating exemplary steps that may take place exporting data using rules and classifications that are statically set in accordance with an embodiment of the present disclosure; and

FIG. 23 illustrates an exemplary flowchart illustrating general steps for using machine learning to generate rules for export and transfer of data in accordance with an embodiment of the present disclosure.

### DETAILED DESCRIPTION OF THE EMBODIMENTS

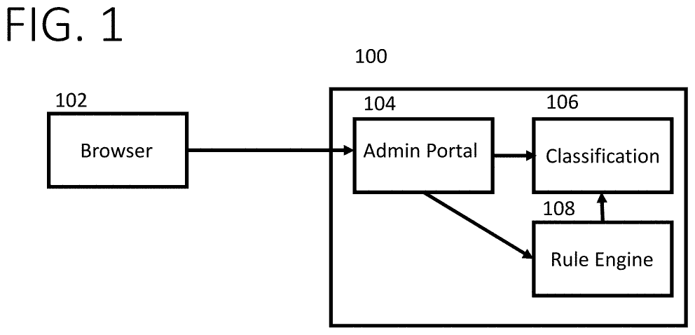

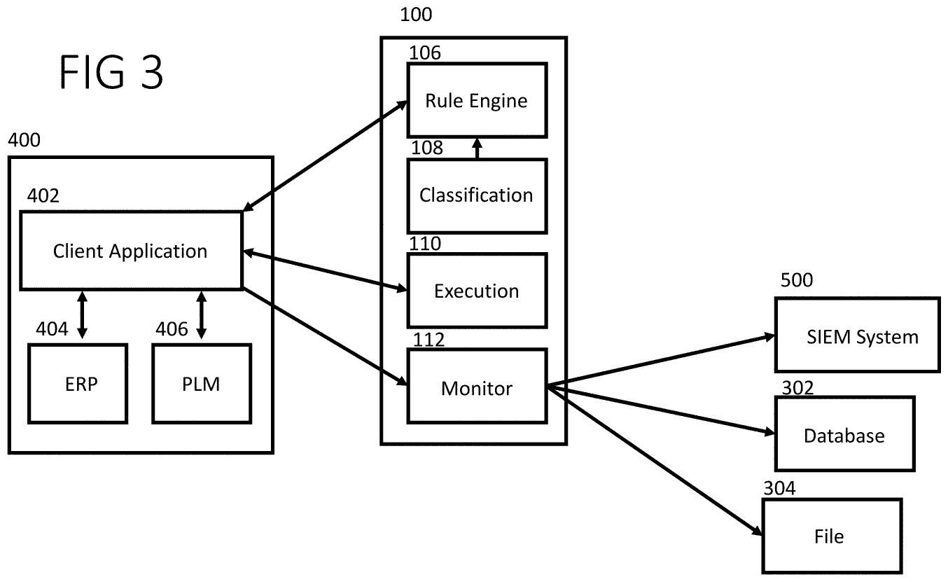

In embodiments, the method and system of the present disclosure may use unsupervised machine learning to extract relevant dimensions and attributes from data related to transactions in a computer system and uses them to build rules related to data transfers and exports in a computer system 100, 400 (see FIG. 1 and FIG. 3 for example). Using unsupervised machine learning, generally, patterns in data may be identified and rules generated. In embodiments, the method and system of the present disclosure also allows users to inspect the produced rules that are produced based on the machine learning and to integrate them into the rule engine 106 of the computer system 100 by inclusion of domain expertise. In FIG. 1, a user or administrator may access the computer system 100 and in particular the rule engine 108 via the portal 104. In embodiments, the classification element 106 may classify data to be exported or otherwise transferred to and from the computer system 400 (see FIG. 3, for example) based on the application of rules by the rule engine 108. In embodiments, domain expertise may vary depending on the ERP environment embodiments, classifications may be defined based on domain expertise, for example, of a user or administrator. In embodiments, the term domain expertise generally relates to information, architecture and/or structure that may be associated with the specific client application 402. In embodiments, the domain expertise may vary depending on the specific ERP environment used in the computer system 400. In embodiments, classifications may be applied based on execution of rules by the rule engine 108. In embodiments, the method and system of the present disclosure combine the strengths of machine learning to dynamically provide, maintain and update rules that with the strengths of a rule engine 108. One advantage of the rule engine 108 is that it makes decisions without requiring a large amount of data that is typically required by machine learning algorithms. More specifically, in embodiments, the system and method of the present disclosure combines usage of unsupervised machine learning and data visualization techniques to present results in an easily interpretable way and allows for automatic creation and maintenance of rules for classifying data exports and transfers in and out of business applications 402 using the computer system 100. While not explicitly shown, the computer system 100 includes one or more processors and is operably connected to one or more memory elements including processor executable instructions that when executed perform the functions of the rule engine 108, classification element 106, execution element 110 and monitor element 112. In embodiments, the computer system 100 may be accessed via a web browser 102 which may connect to an administrator portal 104 of the computer system 100. In embodiments, the computer system 100 may be included in the computer system 400 or operatively connected thereto.

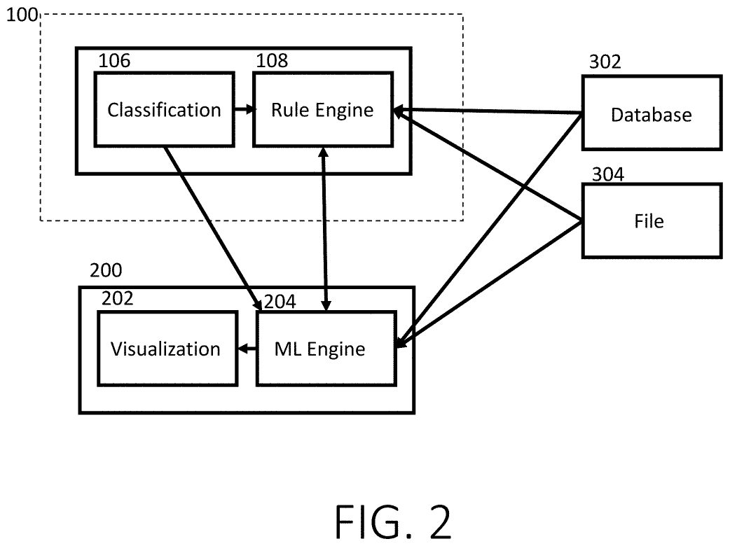

In embodiments, as can be seen in FIG. 2, the rule engine 108 and the classification element 106 may be operably connected to a machine learning module 200 which may include a machine learning engine 204 as well as a visualization/presentation element 202. In embodiments, the machine learning module 200 may be provided in or implemented using the computer system 100. In embodiments, the machine learning module 200 may be provided on or implemented using the computer system 400. In embodiments, the machine learning module 200 may be provided in or implemented using a remote computer system operatively connected to the computer system 100 and the computer system 400. In embodiments, the machine learning engine 204 uses unsupervised machine learning algorithms to analyse data related to data exports and transfers made by the computer system 400 to develop, maintain and update rules that are applied by the rule engine 108. The visualization/presentation element 202 may be used to present the results of the analysis provided by the machine learning engine 204 and/or the suggested rules developed by the machine learning engine 204 based thereon to a user or administrator for further analysis and/or verification. In embodiments, the machine learning engine 204 utilizes data related to data exports and transfers that may be provided from one or more databases, such as databases 302, included in or operatively connected to the computer system 100. In embodiments, the database 302 may include one or more databases or other memory elements or devices. In embodiments, such data may also be provided by individual files such as the file 304 illustrated in FIG. 2. In addition, this data may include historical data that is maintained in a log file that may be stored in the database 302 or elsewhere such as an export log. In embodiments, the machine learning engine of the machine learning module 200, unlike supervised machine learning approaches, does not require a training dataset that is annotated before usage, but instead uses a training example or data without annotations or tags to generate rules. In embodiments, the system and method provide for generation of rules and presentation of analysis without a long human preparation phase by relying on historically collected data that is gathered, stored and accessed by the computer system 100 including, for example, log files and specifically export log files. In embodiments, as noted above, the machine learning engine 204 may also use data included in individual files 304 that are being transferred or exported in or from the computer system 400 to generate the rules. In embodiments, the historically collected data may include data export logs, that is, log data previously provided and stored in a memory, for example, the database 302 of FIG. 2, for example. The log data typically includes context information, user information and destination information, to name a few, associated with each transfer of data into or out of the computer system 400 and within the computer system 400. In embodiments, this data may also be included in individual files 304, as metadata, for example, and may also be used by the machine learning engine 204 as noted above. In embodiments, the method and system present analysis and suggest rules based on an unsupervised machine learning algorithm that groups the historical data according to the selected log attributes identified for the clustering. In embodiments, the computer system 400 may be provided in the computer system 100 or operatively connected thereto. In embodiments, the computer system 400 may include or be operably connected to one or more processors which are operably connected to one or more memory elements that include processor executable instructions that when executed by the one or more processors perform the functions of the client application 402, the ERP element 404 and the PLM 406, for example.

As can be seen with reference to FIG. 3, the client application 402 may provide context and transfer information that may be extracted from data to be exported to the computer system 100. In embodiments, the provided data may be classified based on rules applied by the rule engine 108 into a classification that is defined in the classification element 106. In embodiments, the client application 402 may provide transfer information regarding the data to the monitor element 112 which may record the data in an export log in the database 302, for example, or in a file 304 itself. In embodiments, the monitor element 112 may also include or be operably connected to a security information and event management (SIEM) system 500 associated with the computer system 100. In embodiments, the client application 402 may communicate with an execution element 110, to apply the resulting action and classification of 108 to the exported data/files, for example applying protection/labels or removing them.

In embodiments, the data used to create a rule may include data related to the exported data or files indicating where the data to be classified originates (source information), the destination of the data (destination information), the user triggering the process (user information) and contextual data (context information) from a client application, for example, a client type. In embodiments, the above data may be collected and used and is relevant and applicable to the task or transaction at hand to which the rules for classification will be applied, for example, suggesting financial relevancy, intellectual property, a project number, project name, component name or other data elements and combinations suggesting data relevancy associated with the data. In embodiments, data may also include location information, a time stamp, amount, type of data, destination information, file information, context information, decision information, user information and other parameters. Destination information may include information associated with a device type of the destination device, browser information associated with the destination, operating system information associated with an operating system of the operating system, IP address information associated with an IP address of the destination device, location information associated with the destination device, potential risk factor information associated with the destination device to name a few. In embodiments, the file information may include file path information associated with a file path of a file involved in a transaction, file name information associated with the file name of the file involved in the transaction, file type information associated with the type of file, file protection information associated with prior file protection associated with the file, initial file size information associated with the initial file size, downloaded file size information associated with a size of the downloaded file to name a few. In embodiments, context information may be provided by the source system or device, and may include metadata related to the exported data, for example, system built-in classification associated with a classification associated with the supplied data or file, tcode information associated with the source (in the case where the computer system is using SAP software, for example), workspace name information, product name information, library name information, selected fields and their values associated with the data, object_project information, application name information associate with a source application associated with the file or data, to name a few. In embodiments, the source information may include any information or data from the source system or application that helps clearly identifying the exporting or exported information, Decision information may include information associated with a decision made by the computer system 100 (by the rule engine 108, for example) with respect to the data to be exported, for example, protect, block, monitor or unprotect to name a few. In embodiments, user information may include the user name, full name, user role information, authorizations information associated with the user, user e-mail information, user group information, to name a few to clearly identify the user requesting the data export or transfer. In embodiments, data associated with the data to be exported may be structured using xml or j son or similar technical data exchange formats. In embodiments, the data associated with the data to be exported may retrieved by the client application 402 from the ERP 404 or PLM 406, for example or any other memory device, medium or element included in or operatively connected to the computer system 400 and sent through the computer system 100. In embodiments, the data structure may be compressed for reduced storage size. In embodiments, the data or file to be exported may be used as an input to the rule engine 108 to generate a classification in conjunction with the classification element 106, for example, associated with the data to be exported in accordance with rules implemented with the rule engine 108. In embodiments, application of one or more rules by the rule engine 108 may result in a decision, such as protect, block, monitor or unprotect associated with the data to be exported. In embodiments, this data may also be used by an unsupervised machine learning algorithm, which may be implemented by the machine learning engine 204 for rule development of new rules to be used in the rule engine 108 and or to maintain or update existing rules.

In embodiments, the system 100 uses a rule-based system used to define the results and the processing of single data processes including export or transfer of data. In embodiments, during setup and activation, the system 100 may collect data associated with processed export events for further processing using the machine learning algorithms implemented by the machine learning engine 204. In embodiments, log data associated with prior data export transactions may be provide to the machine learning engine 202 and processed using a machine learning algorithm as well. For example, for each single data process (i.e. data exported as a file) information associated with the file such as context information, user information and destination information, to name a few, may be collected and stored in the log. In embodiments, this data may be included in or associated with an individual file 304 and may be collected or extracted directly form the file to be exported, rather than from the export log. In embodiments, this information may be used by the unsupervised machine learning algorithm implemented by the machine learning engine 204 to generate proposed rules to be implemented by the rule engine 108 to classify data processes in the computer system 400 and make decisions regarding export or other transfers of data, such as protect, block, monitor or unprotect, to name a few. In embodiments, this allows the system to bootstrap with a simple default configuration, thus being in effect without having learned anything about the peculiarity of the specific installation.

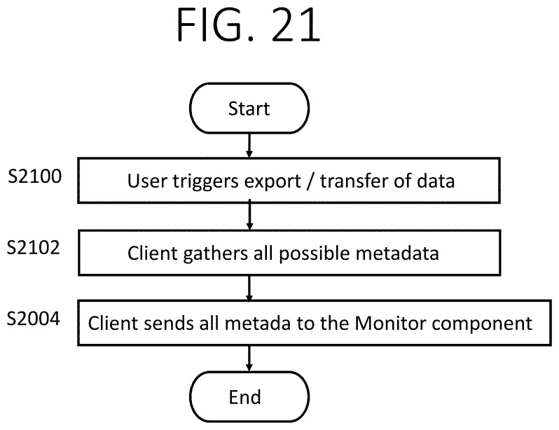

FIG. 21 illustrates an exemplary flow chart illustrating exemplary steps that may take place when a client application 402 requests data for export from the ERP 404 or PLM system 406. In a step S2100, the client application 402 may trigger an export or transfer of data. In embodiments, at step S2102 the client application 402 may gather or extract metadata from the data to be exported, which may be a file, such as file 304, for example. In a step S2104, the client application 402 may provide the metadata to a monitor element 112 of the computer system 112 (see FIG. 3, for example). In embodiments, the metadata may be provided to the database 302 to be included in an export log, for example. In embodiments, the metadata may be included as part of a file reflective of the data exported. In embodiments the metadata may include the source information, the destination information, the user information and/or the contextual information associated with the file. The method of FIG. 21 may be suitable for use in or by the computer system 400,100 at start-up, that is prior to the accumulation historical data related to data export or transfer.

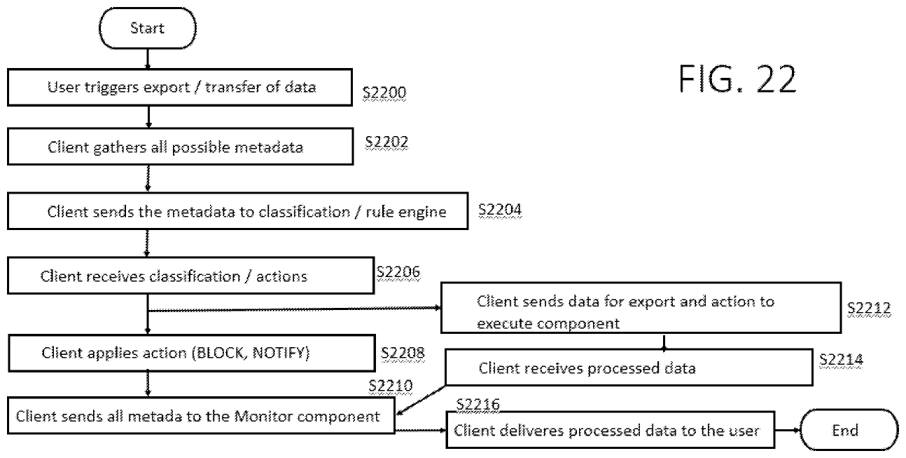

FIG. 22 illustrates another exemplary flow chart illustrating exemplary steps that may take place when a client application 402 requests data for export. In a step S2200, the client application 402 may trigger an export or transfer of data. In embodiments, at step S2202 the client application 402 may gather or extract metadata from the data to be exported, which may be a file, for example. At step S2204, the client application 402 may sent the metadata to the rule engine 108, where the engine may implement the rule set in view of the metadata associated with the data to be exported. In embodiments, this may include providing a classification using the classification element 106 as well as providing decision or action information associated with actions to be taken as determined by the rule set. At step S2206, the classification and action information may be received by the client application. At step S2208, the action received in the step S2206 may be implemented by the client application 402. In embodiments, this may block export or transfer of the data. In embodiments, this may result in export of transfer of the data. In embodiments, the actions may include providing a notification that the data is being exported or blocked to a user or administrator. At a step S2210, the metadata related to the data to be transferred, including the classification and decision or action data may be provided to the monitor element 112. The monitor element 112 may provide the metadata to the database 302 to be included in an export log, for example. In embodiments, at step S2212 the data to be exported is sent to the execution element 110 where it is appropriately processed on behalf of the client application. In embodiments, the processed data is then returned to the client application at step S2214, for example. The processed data may be provided to the monitor element in the step S2210. The method of FIG. 22 may not utilize or implement the machine learning module 200 or engine 204 described above and may be suitable for use by customers or users who define their own rules and classifications and do not want them updated or supplemented.

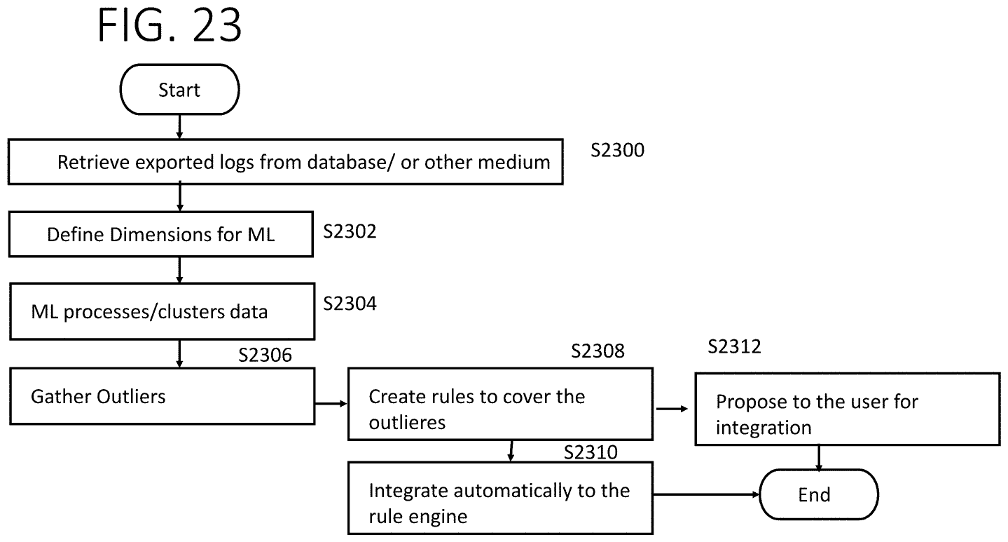

In embodiments, as indicated in FIG. 23, a method of generating rules for data export and transfer by the computer system 400 may begin at a step S2300 in which data associated with data export and transfer may be gathered. This may include the export log data discloses above as well as information extracted from files to the exported or transferred. In embodiments, at step S2302, dimensions may be defined for use by the machine learning engine 204. As noted above, these dimensions may be pre-set based on the machine learning algorithm being used. In embodiments, at the step S2304, the data may be processed using the unsupervised machine learning algorithm implemented by the machine learning engine 204. In step S2306, outlier points are identified in the data. In embodiments, at step S2308, a rule may be generated based on the outlier points. In embodiments, more than one rule may be generated. In embodiments, at step S2310, the one or more generated rules may be added to the rule set applied by the rule engine 108. In embodiments, at step S2312, the generated rule may also be presented to a user for further analysis and verification. In embodiments, some rules that are generate may not be added to the rule engine 108, however, may be useful for analysis and/or added to the data analyzed by the machine learning algorithm implemented by the machine learning engine.

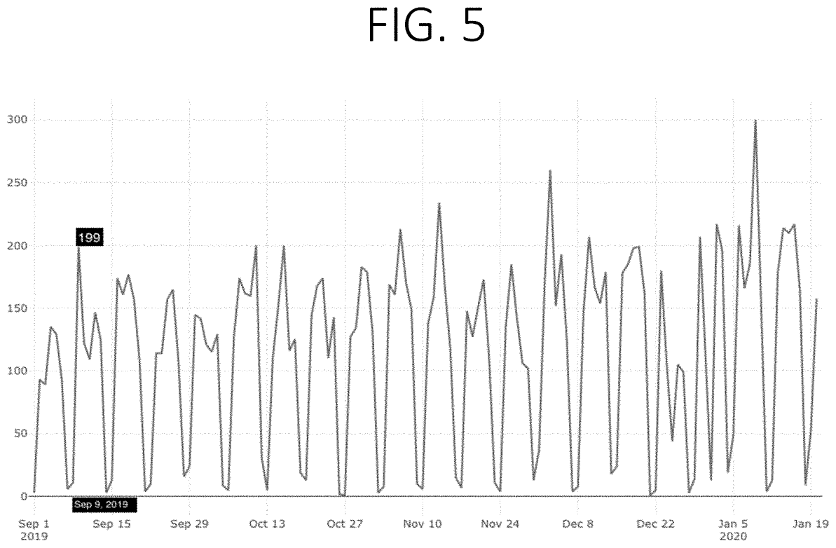

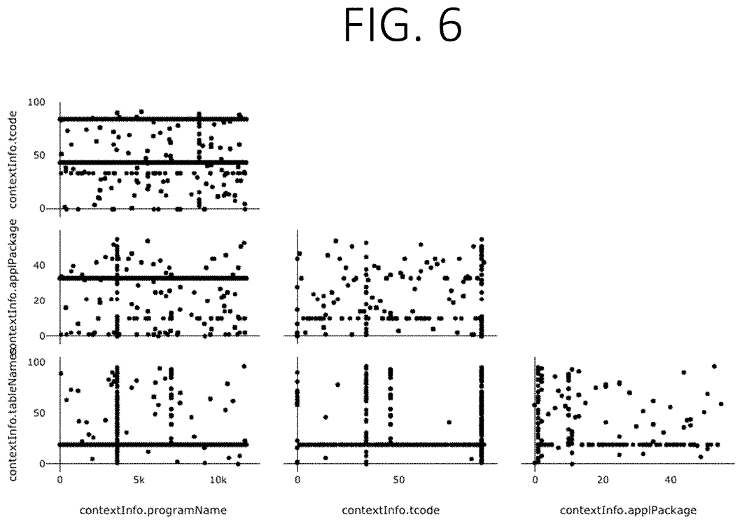

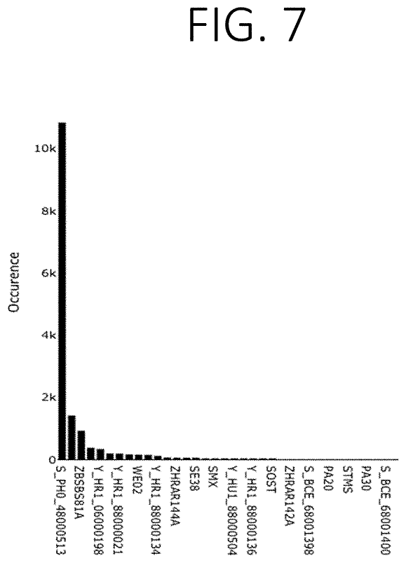

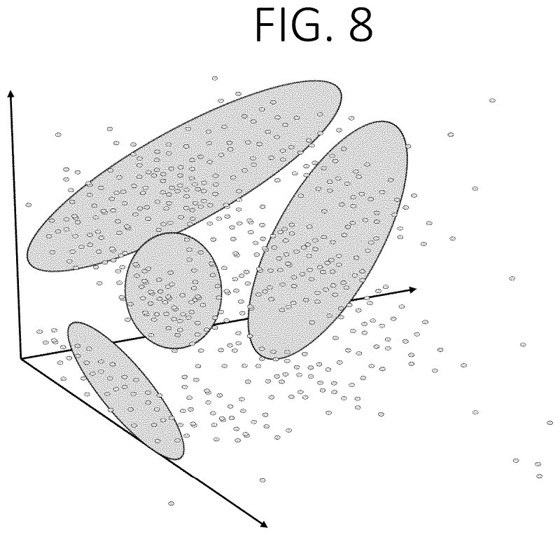

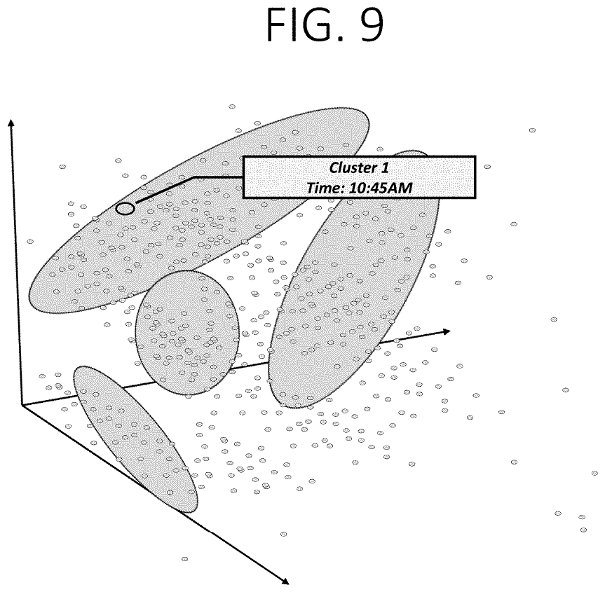

In embodiments, after collection of a substantial and relevant amount of data as described above, data visualization, via the presentation/visualisation element 202, for example, may be provided to support an administrator or other user in analysing the data to validate and improve the existing rule set or to assist the administrator in setting up rules for the first time. In embodiments, rules may be generated and implemented by the machine learning engine 204 and provided to the rule engine 108 with or without administrator analysis or validation. In embodiments, the system and method may use different visualization and analysis techniques, such as time-based visualization (see FIG. 5, for example), correlation capabilities (see FIG. 6, for example) and simple data browsing (see FIG. 7, for example). In embodiments, unsupervised clustering algorithms implemented in the machine learning engine 204 may process the data and construct clusters to identify similar data groups such as those illustrated in FIGS. 8-9, for example, which illustrates multi-dimensional clustering where each of the axes may represent a different attribute, i.e. destination information, context information, etc. In embodiments, the clusters may be used to support creation of new rules or to influence or modify current rules implemented by the rule engine 108. In one example, a proposed rule may define an action based on an event being part of cluster 1 and in the time between 10:00 AM-11:00 AM as indicated in FIG. 9, for example. In embodiments, the action may include blocking export of data or may require issuance of a notification that the data is being exported, to name a few. In embodiments, the action may include assigning a classification to the data which may be used to determine actions based on the same or other rules.

In embodiments, other unsupervised learning algorithms may be used, depending upon their applicability to the problem or transaction. In embodiments, clustering algorithms such as K-Means, DBSCAN, Mean-Shift Clustering to name a few may be used. In embodiments, principle component analysis may also be used. In embodiments, other unsupervised learning algorithms may be used provided that they use clustering. In embodiments, any suitable unsupervised learning algorithm may be used provided that it supports identifying outlier points. In embodiments, data preparation is done in accordance with the requirements of the machine learning algorithm or algorithms used. For example, in embodiments the data may be prepped by converting hour information into text to allow for use by the machine learning algorithm.

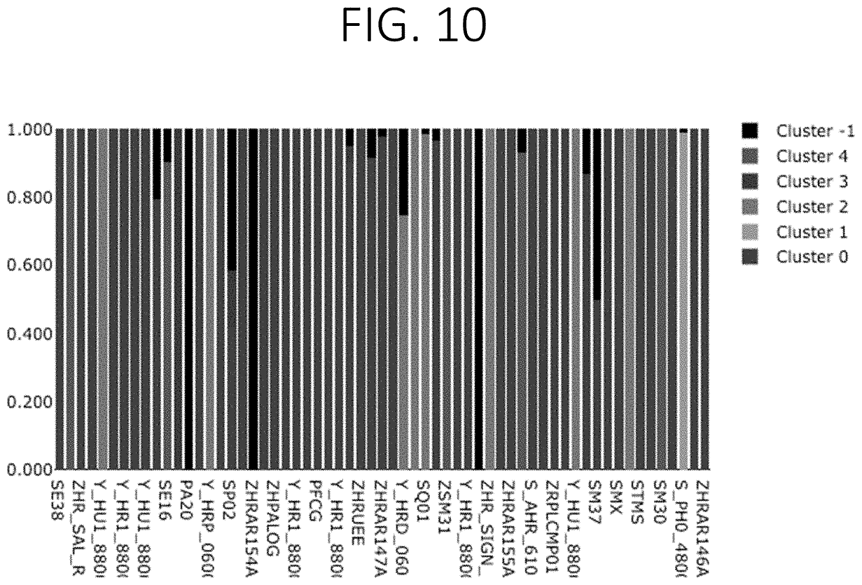

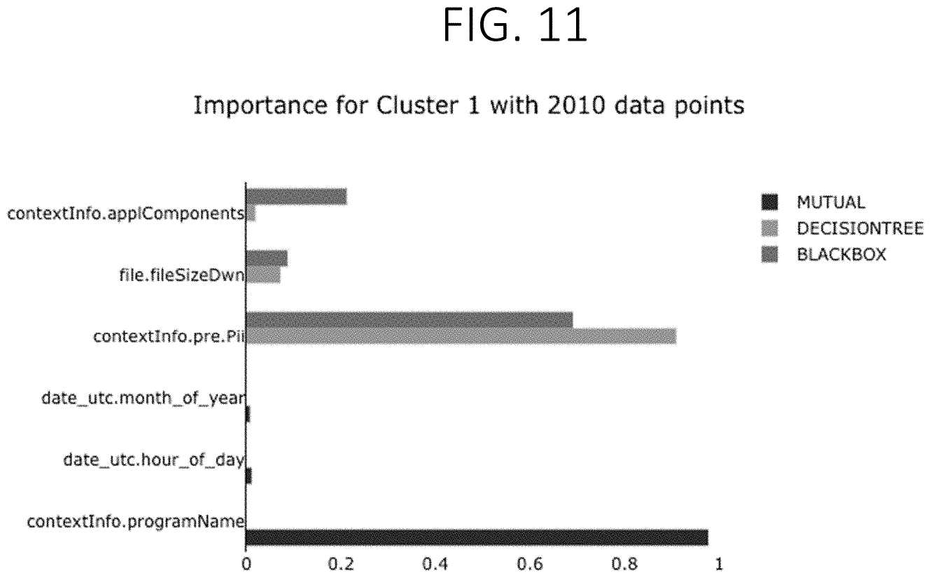

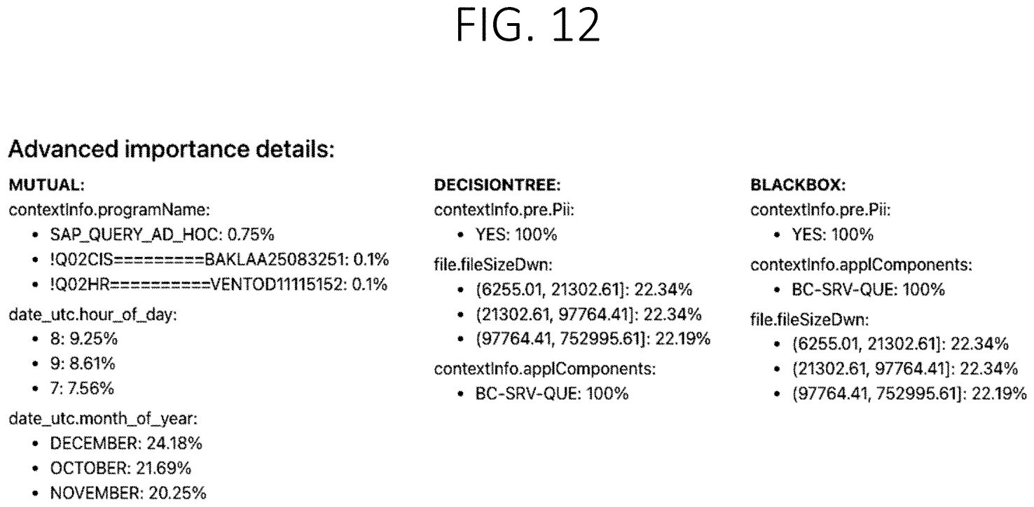

In embodiments, the machine learning algorithm implemented by the machine learning engine 204 may be used to identify regularities in the classified data and creates groups of homogeneous data points. Those groups are known as clusters and may be useful to support human experts in understanding common characteristics of the logs and other data analysed. These clusters may be used to generate rules as noted above. FIG. 10 illustrates an exemplary output of the machine learning algorithm showing the most used values in the data analysed by the algorithm and shows all values of a data attribute and how they were grouped. In embodiments, the system and method may analyse the importance of the different dimensions present in the data and use this ranked list as an explanatory aspect, allowing the users to autonomously characterize and make sense of the created clusters, based on the specific domain knowledge, that is, as noted above, knowledge of the environment of the computer system, and the peculiarity of the computer system 400 monitored. FIG. 11 illustrates an exemplary list of the data in FIG. 10. FIG. 12 illustrates a visual representation of the key aspects of the data identified via the machine learning algorithm. As a side effect, this task provides support for manual inspection and review of existing rules and to identify possible gaps in the security rule set in force in the system. As noted above, the results of the clustering may be presented to a user or administrator via the presentation/visualization element 202, for example.

In embodiments, a complementary approach may be used to consider a set of points that were not collected into a cluster using the machine learning algorithm implemented by the machine learning engine 204. In embodiments, under the assumption that the clusters' elements identified using the machine learning algorithm represent the most common operations executed on the system 400, they are unlikely to provide any directly relevant information about operations connected with security-relevant events. That is, the data that is identified and clustered represents common transactions that are unlikely to be the basis of any new or modified rules. However, as noted above, a rule may be generated to cover events that fit within a cluster. In embodiments, the outlier points that are not grouped into those clusters may be identified as good candidates for a security rule or rule modification since these points represent events that are unusual or rare, and thus may warrant rule creation or modification.

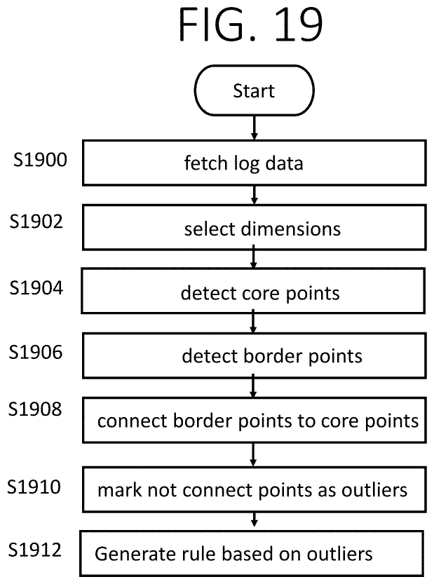

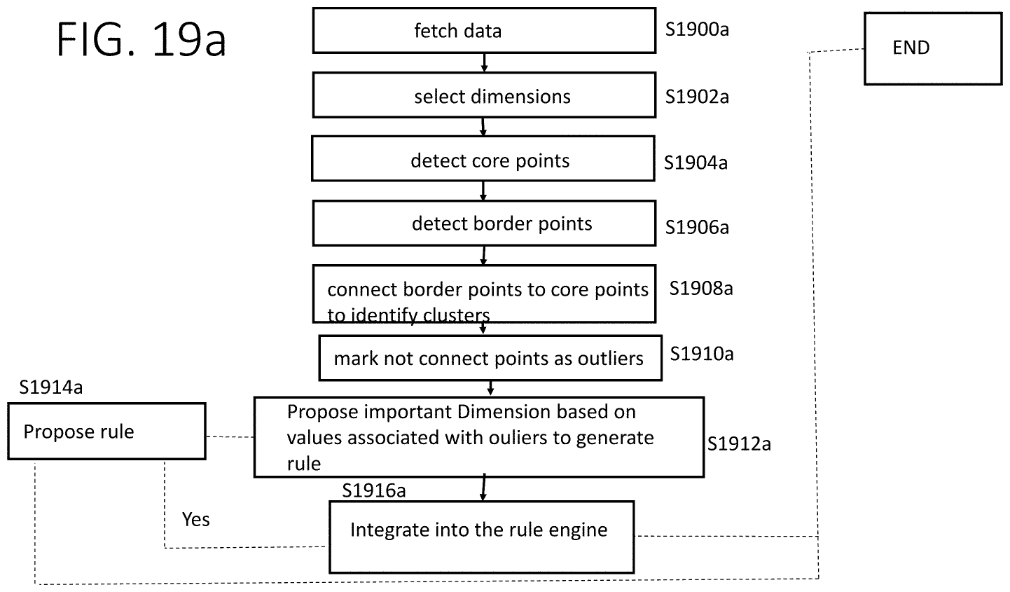

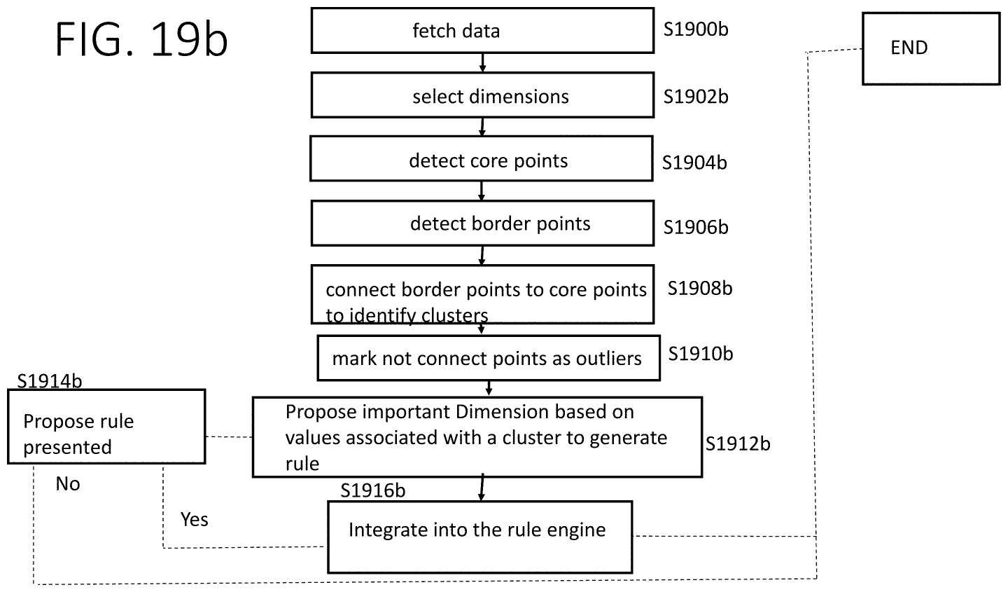

FIG. 19 illustrates an exemplary flow chart showing the steps used to identify these outlier points. In a step S1900, data regarding data transactions in the system 400 may be accessed and retrieved, for example, from the database 302 or any other suitable memory element or device included in or operably connected to the computer system 100. As noted above, in embodiments, relevant data may be provided directly form a file 304 that may be the subject of a transaction. In embodiments, the data may also include export log data. In a step S1902, the dimensions of the log data are identified, for example, destination information, context information, file information, source information etc. In embodiments, the algorithm may include a pre-set list of attributes to be used as dimensions. In embodiments, at step S1904, core data points in the log data are identified. In embodiments, these core data points are those that appear most often in the data. In step S1906, border points in the data are identified. In embodiments, border points may be identified based on their distance from the core points. In embodiments, at step S1908 core points are associated with border points to identify one or more clusters in the data. In a step S1910, outlier points that are not included in the identified one or more clusters are identified. In a step S1912 a new rule may be generated based on the outlier points. In particular, in embodiments, the new rule may be generated to take into account the data points that are identified as outlier points. The outlier points appear in part of the space with a lower density, signalling their lower relative frequency. These outliers are the candidate points for inspection in order to simplify the creation of security-oriented rules since they represent outlier events in the computer system 100 which are more likely to be the basis of new or modified rules.

FIG. 19A illustrates an exemplary flow chart showing the steps used to generate a rule based on outlier points. In a step S1900a, log data may be accessed and retrieved, for example, from the database 302 or any other suitable memory element or device included in or operably connected to the computer system 100. As noted above, in embodiments, relevant data may be provided directly form a file 304 that may be the subject of a transaction. In a step S1902a, the dimensions of the log data are identified, for example, destination information, context information, file information, source information etc. In embodiments, the algorithm may include a pre-set list of attributes to be used as dimensions. In embodiments, at step S1904a, core data points in the log data are identified. In embodiments, these core data points are those that appear most often in the data. In step S1906a, border points in the data are identified. In embodiments, border points may be identified based on their distance from the core points. In embodiments, at step S1908a core points are associated with border points to identify one or more clusters in the data. In a step S1910a, outlier points that are not included in the identified one or more clusters are identified. In step S1912a, important dimensions may be identified in the outlier points based on impact scores and the rule may be generated as noted above. In optional step S1914a, the important dimension and/or the generated rule may be proposed to a user for inclusion in the rule set. In embodiments, if the user approves (“Yes”), at step S1916a, the generated rule may be added to the rule set. If not, the rule may not be added to the rule set. In embodiments, the rule may be added to the rule set in step S1916a without presenting it to the user in optional step S1914a. As noted above, more than one proposed rule may be generated in the generating step. In embodiments, the additional rules generate may not be added to the rule set, that is, may not be provided to the rule engine. These rules may however be useful for analysis and may also be added to the data regarding data transfer that is analyzed by the machine learning engine 204.

In embodiments, the outlier points are ranked based on the relative distance from the closest cluster of points and the importance of each single data dimension is computed in terms of the influence in determining the outlier separation from the clusters 9B. This allows the user or administrator to experience a feeling about the effects that each data dimension has for identifying this part of the space, and can work as an indication of the relevance of a certain outliers for the security configuration of the system at hand.

Based on the list of outliers, a user may define a rule, by presenting each outlier with the value for dimension ranked by importance. In embodiments, the outliers are ranked by importance with the most important outlier used to generate a rule with or without user intervention. The more exactly the rule covers the outlier, including dimension name and dimension value, the less likely it is to capture other similar events, however, this also reduces the likelihood of false positive as well.

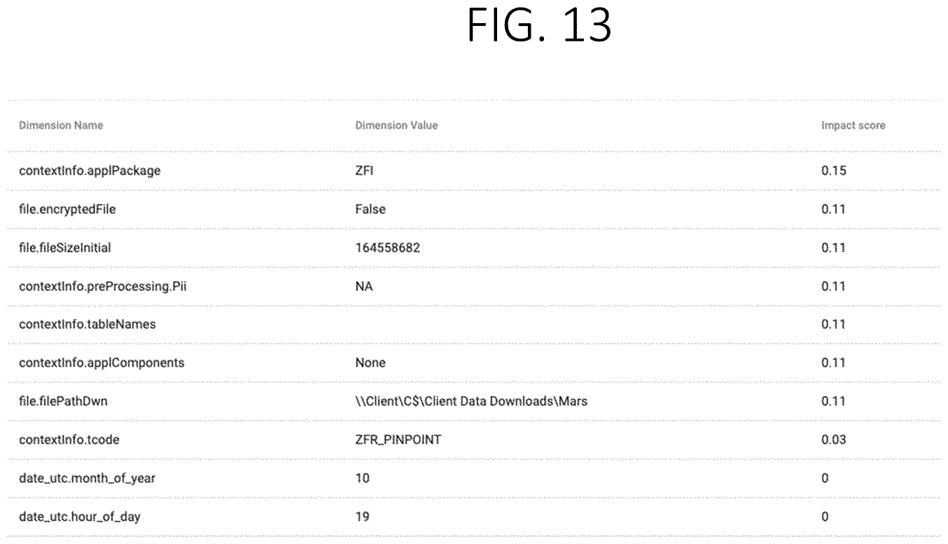

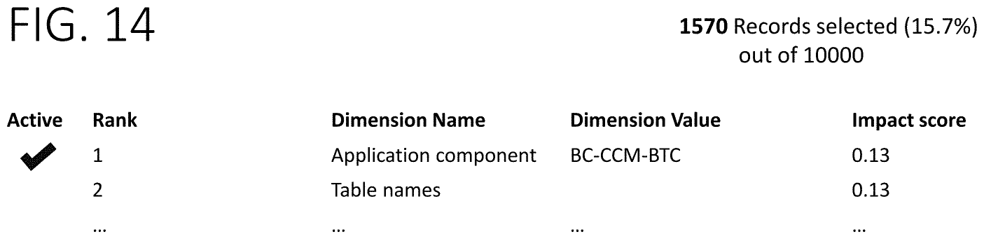

FIG. 13 illustrates an exemplary list of outlier points including respective impact scores indicating their relative importance's well as the associated dimension name and dimension value associated with each. FIG. 14 illustrates ranking of these outlier points which may be accomplished as part of the generating step S1812. In the exemplary case illustrated in FIG. 14, ContextInfo.applComponent=‘BC-CCM-BTC’ may be proposed as a rule or condition to be met as part of a rule and a corresponding classification may be associated therewith. In embodiments, the domain expert, who may be an administrator or other user, may provide a corresponding classification associated with meeting this condition. In embodiments, a classification may be assigned automatically based on other rules or conditions included in the rule set. In this particular case, such a rule would cover 15.7% of the outlier points. In embodiments, the user may be able to include or exclude any represented dimension in a new rule. In embodiments, the new rule may be added to the rules implemented by the rule engine 108 without user review. Additionally, the user may also exclude irrelevant values from a dimension or interact with the numerical ranges of a numerical attribute, in order to tailor the resulting rule to the use case. In embodiments, such tailoring may be implemented or provided based on other rules or conditions provided in the rule set. Providing for user tailoring allows seamlessly including the domain expertise of the user, that is the user's knowledge of the computer system 400, into the created rules, without an explicit need to formulate this knowledge and without the need for the user to generate rules from scratch. In embodiments, this step works also as an explicit approval operation from a human expert, allowing full control over the system behaviour by users (so known human-in-the-loop approach). As noted above, however, the rule may be generated and implemented without user approval if desired.

FIG. 19B illustrates and exemplary flow chart illustrating the steps used to generate a rule based on one or more clusters. In a step S1900b, log data may be accessed and retrieved, for example, from the database 302 or any other suitable memory element or device included in or operably connected to the computer system 100. As noted above, in embodiments, relevant data may be provided directly form the source system or a file 304 that may be the subject of a transaction. In a step S1902b, the dimensions of the log data are identified, for example, destination information, context information, file information, source information etc. In embodiments, the algorithm may include a pre-set list of attributes to be used as dimensions. In embodiments, at step S1904b, core data points in the log data are identified. In embodiments, these core data points are those that appear most often in the data. In step S1906b, border points in the data are identified. In embodiments, border points may be identified based on their distance from the core points. In embodiments, at step S1908b core points are associated with border points to identify one or more clusters in the data. In a step S1910b, outlier points that are not included in the identified one or more clusters are identified. In step S1912b, important dimensions may be identified in the clusters based on impact scores and the rule may be generated as noted above. In optional step S1914b, the important dimension and/or the generated rule may be proposed to a user for inclusion in the rule set. In embodiments, if the user approves (“Yes”), at step S1916b, the generated rule may be added to the rule set. If not, the rule may not be added to the rule set. In embodiments, the rule may be added to the rule set in step S1916b without presenting it to the user in optional step S1914b.

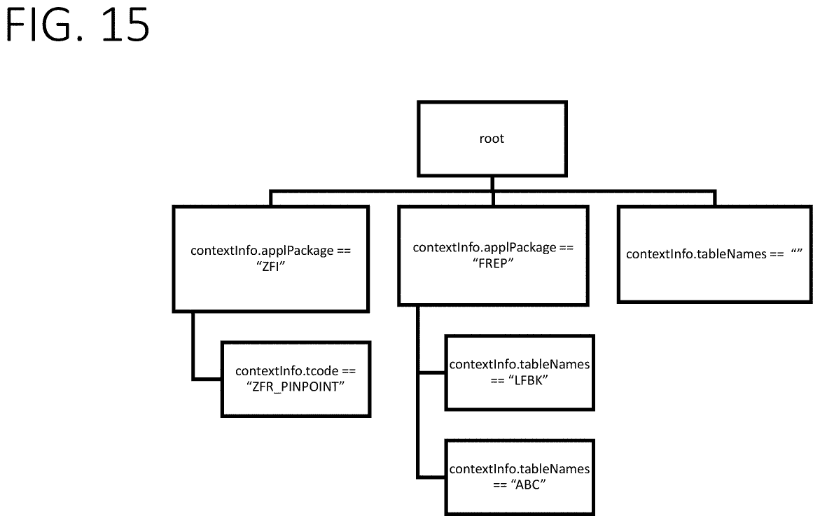

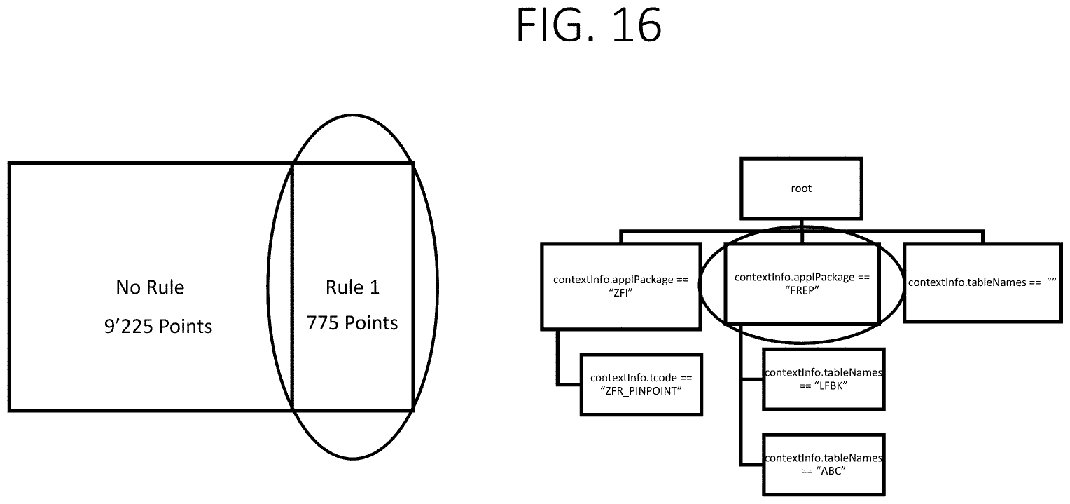

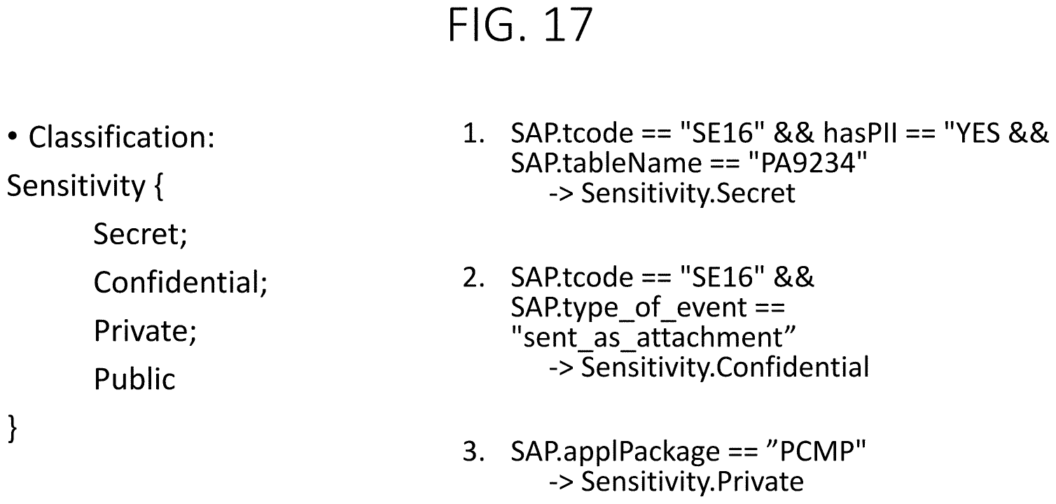

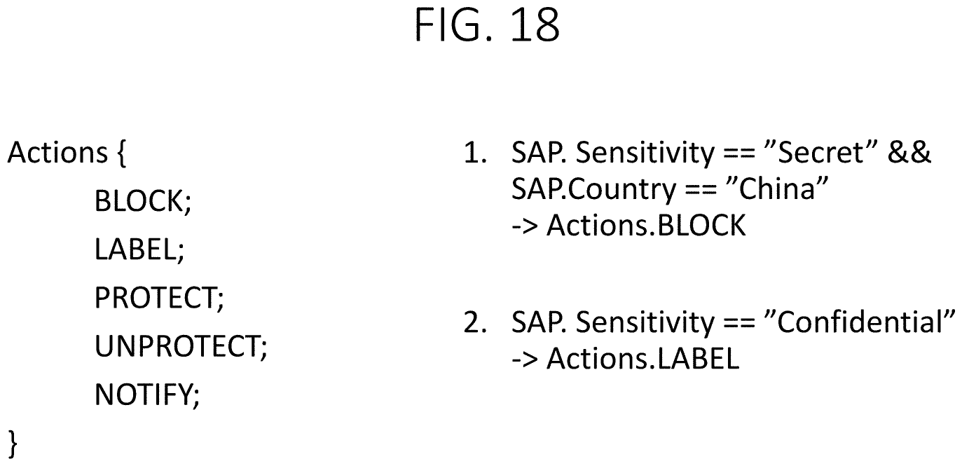

The rules may then be ordered based on the number of conditions, such that more specific rules are evaluated at first. FIG. 17 illustrates exemplary rules including the relevant conditions and resulting classifications for each. For example, the first rule 1 in FIG. 17 indicates that data with conditions including: (1) a tcode of “SE16”, that (2) includes personal identifying information (has PII==YES) and has (3) a table name of “PA9234” may be classified as “Secret.” Rule 2 of FIG. 17 includes fewer conditions and is classified as confidential. FIG. 18 illustrates additional rules including actions or decisions associated with each. For example, where data is classified as Secret and provided in China, export may be blocked. In another example, where data is classified as confidential, the data may be marked as such and exported. Based on the functioning of the rule engine 108 this operation is fundamental, as the first approved rule that is triggered is executed and stops the interpretation of further ones. Consequently, each single rule may represent a branch in a set of logical decision trees. FIG. 15 illustrates as example of such a decision tree. The security expert may then able to access an interface, via the visualization element 202, for example, where it will be possible to explore these decision trees, for ease of inspectability and explainability of the resulting rules set. That is, the tree may be used to provide an overview of the rule set and the interaction between the rules thereof. In this interface, the user may be presented with a decision tree map where each node may be represented with a rectangle whose surface correlates with the number of data points effectively matching it. Then, by selecting a rectangle, the respective nodes in the tree gets highlighted. FIG. 16 illustrates an example of this. The intensity of the highlight may be directly proportional to the depth in the tree that the classification rule reaches for the current selected outlier. In this way, the user or administrator may identify trees that are more relevant for the exploration. In embodiments, relevance of a tree may be based on data classification relevancy which may be based on a business case or activity at hand. In embodiments, a tree may be considered more relevant for a PLM system than it is for a HR SAP system. The user may also click and select a specific rectangle, in this way expanding on the left side of the view a comprehensive view of the relevant decision tree as indicated in FIG. 16, for example. In this panel, the user is able to explore and evaluate the decision tree resulting and its effect on the outlier classification. That is by following the decision tree the user may determine how outlier points relate to each and how a rule based on an outlier may affect the other outlier points. This can be useful for supporting operations such as rules validation and modification, on needs.

In embodiments, the classification produced by the rule engine 108 and classification element 106 may be added to extend the already existing data for the input of the clustering algorithm implemented by the machine learning engine 204. This allows human expertise to take part in the analysis and making it an independent additional dimension, describing each event's security relevance. In embodiments, using the additional dimension with the others in the clustering algorithm implemented by the machine learning engine 204 to discover new aspects to consider for the rule definition or providing the possibility to explore the visual representation.

In embodiments, the rules, suggested by the system and authorized by the user may be added to the rule engine 108. In embodiments, the rule engine 108 determines the classification of new data exports for the real-time protection of the data based on the rules. In embodiments, the resulting classification may be used as input for other supervised machine learning approaches implemented by the machine learning engine 204. This is a beneficial feature, as the amount of annotated data required by a scalable and reliable machine learning approach on such a large data space is normally not affordable, given the time and effort required by manual annotation of the incoming data. In embodiments, the resulting rules from the unsupervised machine learning approach may be used to validate the already existing rule set and extend it.

In embodiments, the clustering algorithm implemented by the machine learning engine 204 to determine the outliers may be executed iteratively to improve results. Discovering interesting new facts about the data characterization and spotting additional points to consider for the rule definition. One advantage of this approach is that it is reactive to changing conditions or system usage, without the need to collect a large amount of data for the initial results. This may support a better confidence in the clustering and outlier identification processes, as the random noise effect tends to disappear on larger datasets.

In embodiments, rule sets may be stored in a file, a database or any other storage medium operatively connected to the computer system, including the database 302, for example. In embodiments, the processed and collected event data (export logs, for example), which include the historical data such as context information, user information and destination information, to name a few, related to individual events of data transport may be stored on a client application side and transferred at a later point to the present system or may be saved in a file, database or other storage medium operatively included in or connected to the system of the present disclosure. In embodiments, the method and system may be implemented via a remote server or other computer system 100 with access to the computer system 400 for which the rule set applies. In embodiments, the method and system may be implemented in the computer system 400 for which the rule set applies.

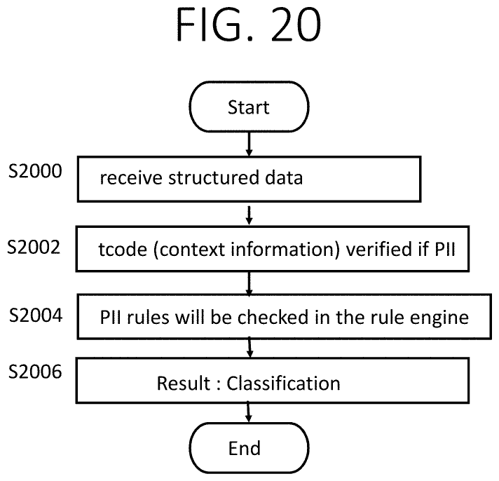

In embodiments, rules may be applied directly to the structured data to be exported, however, pre-processing may be provided for additional effectiveness. For example, the substantial and relevant data may be supplemented with additional knowledge by a user before being processed by the rule-based system or the machine learning algorithms of the machine learning engine 204. In embodiments, the context information, user information and destination information discussed above may be supplemented by user input. In embodiments, the supplemental data may include data indicating that certain data contains personal identifiable information (PII). For example, FIG. 20 illustrates a method by which a pre-processing engine implemented via the machine learning engine 204 or operably connected thereto may identify additional data to be included in the defined knowledge. In Step S2000 the structured data may be received. As noted above, this data may include historical data as well as files or other data to be exported or otherwise transported. At step S2002, a tcode, in the case of an SAP system, may be identified in the context information to verify the presence of PII. At step S2004, rules related to PII may then be identified in the rule set and applied to the data to generate the appropriate classification based on the rules related to PII. At step S2006 those rules may be implemented to classify the data in accordance with the rules. In embodiments, a supervised machine learning algorithm implemented by the machine learning engine 204 may be used to propose further data which should be part of the defined knowledge. For example, the supervised algorithm might be used to determine usage of certain documents within a PLM (product lifestyle management) application. The analysed usage might then be categorized by a human as proper action or improper action. This information might then be forwarded to the machine learning engine 204 and rule engine 108 as additional input to all other collected information. The newly created information might be used as further data input and enhance the value of the data and provide additional input to the main engine.

In addition, other pre-processing mechanisms may include grouping certain values so subsequent rules are easier to understand. For example, in embodiments portions of relevant data may be grouped into a field “USA.” In embodiments, location or origin information may be determined based on IP Range or other location information from the server or other computer system from which data is exported. In embodiments, contextual or destination information may also be used in grouping. In embodiments, additional rules may be proposed based on this data to indicate that this is the United States which may be added to the current contextual data and used for classification of the data. In embodiments, additional steps may take place at the source system to provide pre-processed information and enhance the quality of the collected information related to the data to be exported. For example, on an SAP source system, an SAP specific data processing takes place and enhances the collected context, destination or similar information. The enhancement could source additional information based on certain values from other tables or programs. In embodiments a completely independent rule system may be developed to handle source system specifics and provide metadata as output to the main rule engine.

In embodiments the classification result and decision of all different rules, engines and algorithms, might be stored with the initial dataset to create new clusters and improve the systems data quality on subsequential runs. For example, a rule set may be derived from a cluster and enhanced with rules known by humans. The information after processing is stored within the data records and on a next run to regenerate the clusters, new clusters are hence created, taking into account the knowledge of previous runs.

In embodiments, the data may need to be transformed such that learning algorithms implemented by the machine learning engine 204 are easily applied.

In embodiments, a consumer application may gather all possible contextual information of downloaded data and transform it into structured data as in FIG. 3, for example. For example, table names may be collected indicative of the source of the downloaded data. In embodiments, the structured data may be communicated to the system of the present disclosure. In embodiments, the structured data may be pre-processed as noted above. In embodiments, the rule-based system may include at least two parts. In embodiments, the first part may be the rule engine 108 and the second part may be the specified rules or classifications such as those provided by the classification element 106. In embodiments, the engine 108 may be based on a grammar specification, currently specified in a file. In embodiments, a script language may be developed to represent the rules and may be executable by the rule-based engine 108. The grammar specification provides the grammar that the rule-based engine executes or implements. In embodiments, the grammar specification may be stored in other storage media. In embodiments, the engine 108 may interpret the configured rules currently stored in a file or otherwise to classify input data to the engine. In embodiments, the rules may come from a database or another storage medium. In embodiments, when the rules are loaded, the structured data is assigned classification data bases on a classified data action indicated by the rules. In embodiments, the classifications may be defined by customers or users and thus may vary, but may include classes such as Sensitivity: Secret, Confidential; Private, Public, to name a few.

Now that embodiments of the present invention have been shown and described in detail, various modifications and improvements thereon can become readily apparent to those skilled in the art. Accordingly, the exemplary embodiments of the present invention, as set forth above, are intended to be illustrative, not limiting. The spirit and scope of the present invention is to be construed broadly.

What is claimed is:

1. A method of providing and updating a rule set for classifying actions and transactions in a computer system comprises:
accessing, by a machine learning engine operably connected to the computer system, data associated with data transactions made by the computer system;
determining, by the machine learning engine, one or more dimensions associated with the data;
identifying, by the machine learning engine, one or more core points associated with the data;
identifying, by the machine learning engine, one or more border points associated with the data;
connecting, by the machine learning engine, the one or more core points to the one or more border points;
identifying, by the machine learning engine, one or more clusters based on the one or more core points and the one or more border points to which they are connected;
identifying, by the machine learning engine, one or more outlier points that are not connected to one or more border points; and
generating, by the machine learning engine, a first proposed rule based on at least one of the one or more clusters and/or the one or more outlier points.

2. The method of claim 1, further comprising, sending the first proposed rule to a rule engine associated with the computer system.

3. The method of claim 2, further comprising, prior to the sending step, a step of presenting, by the machine learning engine, the first proposed rule generated to a user via a visualization element operably connected to the computer system.

4. The method of claim 3, further comprising receiving, by the machine learning engine, verification of the first proposed rule generated in the generating step from the user via the visualization element prior to the sending step.

5. The method of claim 3, wherein the generating step includes generating at least a second proposed rule, wherein the second proposed rule is not sent to the rule engine.

6. The method of claim 5, further comprising a step of storing the first proposed rule generated by the generating step and the second proposed rule with the data associated with data transactions, wherein the first proposed rule generated by the generating step and the second proposed rule are included in the data associated with data transactions when the accessing step is repeated.

7. The method of claim 1, further comprising preprocessing the data associated with data transactions before the accessing step.

8. The method of claim 1, wherein the data associated with the data transactions includes export data log information associated with prior exports of data.

9. The method of claim 1, wherein the data associated with the data transactions includes metadata associated with a file to be exported.

10. The method of claim 1, wherein the data associated with the data transactions includes rules previously generated for the rule set.

11. The method of claim 1, wherein the dimensions associated with the data are determined based on a preset list associated with the machine learning engine.

12. The method of claim 1, further comprising storing, by the machine learning engine, the one or more core points, the one or more border points and the one or more outliers is a memory element operably connected to the computer system.

13. The method of claim 1, further comprising presenting, by the machine learning engine, one or more of the one or more core points, the one or more border points and the one or more outliers to a user via a visualization element operably connected to the computer system.

14. The method of claim 1, further comprising, generating, by the machine learning engine at least one logic tree based on the first proposed rule generated in the generating step and a rule set associated with a rule engine operatively connected to the computer system.

15. The method of claim 14, further comprising presenting the at least one logic tree to a user via a visualization element operably connected to the computer system.

16. A system providing and updating a rule set for classifying actions and transactions in a computer system comprises:
at least one processor;
at least one memory element operably connected to the at least one processor and including processor executable instructions, that when executed by the at least one processor performs the steps of:
accessing data associated with data transactions made by the computer system;
determining one or more dimensions associated with the data;
identifying one or more core points associated with the data;
identifying one or more border points associated with the data;
connecting the one or more core points to the one or more border points;
identifying one or more clusters based on the one or more core points and the one or more border points to which they are connected;
identifying one or more outlier points that are not connected to one or more border points; and
generating a first proposed rule based on at least one of the one or more clusters and the one or more outlier points.

17. The system of claim 16, wherein the memory element includes processor executable instructions, that when executed by the at least one processor perform a step of sending the first proposed rule to a rule engine associated with the computer system.

18. The system of claim 17, wherein the memory element includes processor executable instructions, that when executed by the at least one processor perform a step of, prior to the sending step, presenting the first proposed rule generated in the generating step to a user via a visualization element.

19. The system of claim 18, wherein the memory element includes processor executable instructions, that when executed by the at least one processor performs a step of receiving verification of the first proposed rule generated in the generating step from the user via the visualization element prior to the sending step.

20. The system of claim 18, wherein the memory element includes processor executable instructions that when executed by the at least one processor perform a step of generating a second proposed rule wherein the second proposed rule is not sent to the rule engine.

21. The system of claim 20, wherein the memory element includes processor executable instructions, that when executed by the at least one processor performs the step of storing the first proposed rule generated by the generating step and the second proposed rule with the data associated with data transactions, wherein the first proposed rule generated by the generating step and the second proposed rule are included in the data associated with data transactions when the accessing step is repeated.

22. The system of claim 16, wherein the memory element includes processor executable instructions, that when executed by the at least one processor perform a step of preprocessing the data associated with data transactions before the accessing step.

23. The system of claim 16, wherein the data associated with the data transactions includes export data log information associated with prior exports of data.

24. The system of claim 16, wherein the data associated with the data transactions includes metadata associated with a file to be exported.

25. The system of claim 16, wherein the data associated with the data transactions includes rules previously generated for the rule set.

26. The system of claim 16, wherein the dimensions associated with the data are determined based on a preset list associated with the machine learning engine.

27. The system of claim 16, wherein the memory element includes processor executable instructions, that when executed by the at least one processor perform a step of storing, by the machine learning engine, the one or more core points, the one or more border points and the one or more outliers is a memory element operably connected to the computer system.

28. The system of claim 16, wherein the memory element includes processor executable instructions, that when executed by the at least one processor perform a step of presenting, by the machine learning engine, one or more of the one or more core points, the one or more border points, the one or more clusters and the one or more outliers to a user via a visualization element operably connected to the computer system.

29. The system of claim 16, wherein the memory element includes processor executable instructions, that when executed by the at least one processor perform a step of generating, by the machine learning engine at least one logic tree based on the first proposed rule generated in the generating step and a rule set associated with a rule engine operatively connected to the computer system.

30. The system of claim 29, wherein the memory element includes processor executable instructions, that when executed by the at least one processor perform a step of presenting the at least one logic tree to a user via a visualization element operably connected to the computer system.
